(19) United States
(12) Patent Application Publication
(10) Pub. No.: US 2018/0176030 A1
(43) Pub. Date: Jun. 21, 2018

(54) DEVICE FOR ASSISTING A USER IN A HOUSEHOLD

(71) Applicant: BSH HAUSGERAETE GMBH, MUENCHEN (DE)

(72) Inventors: DUC HANH BUI TRAN, MUENCHEN (DE); ARNE ROST, STARNBERG (DE); FRANK SCHAEFER, PUCHHEIM (DE); LUCIA SCHUSTER, MUENCHEN (DE)

(21) Appl. No.: 15/736,388

(22) PCT Filed: May 20, 2016
(86) PCT No.: PCT/EP2016/061404

§ 371 Date: Dec. 14, 2017

(30) Foreign Application Priority Data
Jun. 15, 2015 (DE) 102015210879.1

(51) Int. Cl. H04L 12/28; G10L 15/26; G06F 3/16; H04N 9/31; G09B 19/00; G09B 5/06

(52) U.S. Cl. CPC H04L 12/282; H04L 12/2829; G10L 15/265; G09B 5/067; H04N 9/3173; G09B 19/0092; G06F 3/167

(57) ABSTRACT

A device for assisting a user in a household includes a base for placing the device onto a standing surface. A first interaction unit includes an optical sensor capturing image data of a sensed region of an environment of the device. The first unit is movable relative to the base to change the sensed region. A second interaction unit includes a projector projecting an image onto a projection surface in the environment of the device. The second unit is movable separately from the first unit to change the projection surface. A control unit determines a position of a user of the device in the environment of the device and triggers the movement of the first and second units in accordance with the position of the user. The control unit determines an input of the user and causes the projector to project an image onto the projection surface in response thereto.

The invention relates to a device for assisting a user in a household, in particular for control and monitoring of home appliances.

Households typically have a plurality of home appliances available to them, in particular a plurality of household appliances, such as e.g. a refrigerator, an oven, a cooker etc. The home appliances can be used for example for keeping foodstuffs at a particular temperature and for producing meals or dishes from the foodstuffs. The management of a household involves a plurality of different tasks, such as e.g. obtaining and maintaining a stock of foodstuffs, the selection of recipes for the preparation of meals, the production of meals etc.

The present document is concerned with the technical object of providing a device that assists a person in a household in carrying out the plurality of tasks in a household in an efficient way.

The object is achieved in each case by the subject matter of the independent claims. Advantageous forms of embodiment are described inter alia in the dependent claims and subsequent description or are shown in the enclosed drawing.

In accordance with one aspect, a device for assisting a user in a household will be described. The device will also be referred to in this document as a personal kitchen assistant, abbreviated to PKA. The device comprises a base, with which the device can be placed on a standing surface (e.g. on a worktop in the kitchen). In this case the base can be immovable in relation to the standing surface in the installed state of the device. In particular a user can place the device on a standing surface by means of the base, so that the device stands securely and stably on the standing surface (even if parts of the device move, as they do for example in the interaction units mentioned below).

Furthermore the device comprises a first interaction unit having an optical sensor (e.g. a still image camera or a video camera), which is configured to capture image data from a sensed region of an environment of the device. In this case the sensed region typically has a specific, restricted horizontal angular range of the environment of the device. This means that typically the entire horizontal angular range of 360° of the environment of the device cannot be sensed at the same time by the optical sensor. Typical sensed regions have a horizontal angular range of 120°, 90° or less. The first interaction unit can be moved relative to the base (e.g. by means of a first actuator, such as by means of a first electric motor), in order to change the sensed region (in particular in the horizontal direction).

Moreover the device comprises a second interaction unit, which has a projector (e.g. a pico projector), which is configured to project an image onto a projection surface in the environment of the device. In this case the projection surface is typically restricted to a particular horizontal angular range (e.g. of 60° or less). The second interaction unit can be moved separately from the first interaction unit (e.g. by means of a second actuator, such as by means of a second electric motor) around the projection surface of the projector.

The device further comprises a control unit, which comprises a processor and control software for example. The control unit is configured to determine a position of a user of the device in the environment of the device. In particular the position can be determined relative to the device. The position of the user can be detected for example on the basis of the image data of the optical sensor. Furthermore the control unit is configured to cause the first interaction unit and the second interaction unit each to be moved as a function of the position of the user. Moreover the control unit is configured to determine an input of the user (e.g. on the basis of the image data of the optical sensor) and to cause the projector to project an image onto the projection surface in response to the input.

An effective assistance of a user in the household is made possible by the device. In particular it is made possible by the provision of (at least) two separate interaction units, which can be moved separately from one another, for a user to enter inputs (e.g. instructions) in an effective manner (e.g. via a first interaction unit facing towards the user) and to receive corresponding outputs (e.g. via a second interaction unit facing away from the user).

The control unit can be configured to cause the first interaction unit to be moved in such a way that the user is located at least partly in the sensed region of the optical sensor. The first interaction unit can thus be moved towards the user. In this way effective inputs by the user are made possible (e.g. by evaluating the image data). Furthermore the second interaction unit can be moved in such a way that both the projection surface and also the device lie in the field of view of the user (starting from the current position of the user). The second interaction unit (in particular the projector of the second interaction unit) can thus be moved away from the user. In this way it can be guaranteed that the user can view the projected output, starting from the current position of the user, and inputs at the device continue to be made possible.

The device can comprise a first actuator (e.g. a first motor), which is configured to move the first interaction unit around a first axis of rotation in response to a first control signal of the control unit, in order to make possible different sensed regions in a horizontal angular range of 360° around a first axis of rotation. Moreover the device can comprise a second actuator (e.g. a second motor), which is configured to move the second interaction unit around a second axis of rotation, in response to a second control signal of the control unit, in order to make possible different projection surfaces in a horizontal angular range of 360° around a second axis of rotation. In this case the first and the second axis of rotation can be identical if necessary. Through the rotation of the interaction units a flexible alignment of the device in relation to the position of the user is made possible.

The device can comprise acoustic sensors (e.g. as a part of the first interaction unit and/or as a part of the base), which are each configured to detect acoustic data relating to acoustic signals in the environment of the device. An acoustic sensor can comprise a microphone. The acoustic sensors can be arranged at different points of the device. In this way it can be achieved that acoustic signals that are triggered by the user (e.g. voice instructions of the user) have different delay times to the different acoustic sensors.

The control unit can be configured, on the basis of the acoustic data, to detect the presence of the user in the environment of the device. For example it can be detected that the user has given a voice instruction to the device. Furthermore the control unit can be configured, on the basis of the acoustic data of the plurality of acoustic sensors, to determine the position of the user. In particular the delay times of acoustic signals can be evaluated for this purpose. The use of acoustic sensors thus makes it possible to determine the position of the user. The position can be determined in this case independently of a current alignment of the first interaction unit. Furthermore the use of at least one acoustic sensor makes possible convenient interaction with a user using natural language.

The control unit can be configured, on the basis of the acoustic data of the plurality of acoustic sensors, to determine a first position of the user. In this case the first position can correspond to a relatively rough estimation of the actual position of the user. The control unit can then cause the first interaction unit to be moved as a function of the first position of the user, so that the user is located at least partly in the detection area of the optical sensor. Then, in a further step, on the basis of the image data, a second position of the user can be determined. The position of the user can typically be determined with a greater precision on the basis of the image data. The second position thus typically represents a more precise estimation of the actual position of the user than the first position. The control unit can then cause the first interaction unit and the second interaction unit to be moved as a function of the second position of the user. In this way there can be a robust and precise alignment of the interaction units of the device and thus an effective interaction with a user.

The device can comprise a memory unit, which is configured to store profile data in relation to one of more predefined users. The profile data can comprise characteristics (e.g. a voice profile and/or a pictorial appearance profile) of the one or more predefined users, wherein the characteristics make it possible to identify a user. The control unit can be configured, on the basis of the profile data and also on the basis of the acoustic data and/or the image data, to determine whether the user corresponds to a predefined user. Thus the device can identify a user in an effective way and can be adapted for this user. To this end the profile data can if necessary comprise further information in relation to the user, such as e.g. information in relation to preferences, habits etc. of the user. In this case the functionality of a unique identification of a user can be provided if necessary as an option, which can be deactivated by a user (e.g. on grounds of data protection). Furthermore profile data for identification of a user can be stored for data protection exclusively locally in the memory unit of the device.

The control unit can be configured to transfer the device from a sleep mode into an active mode as a function of the acoustic data. In this way there can be a convenient activation of the device via acoustic signals (in particular via a voice input). As an alternative or in addition the control unit can be configured, on the basis of the acoustic data by means of intuitive voice control, e.g. on the basis of natural language processing, to determine the input of the user. In this way, by the use of natural human speech, instructions can be given in an effective way by a user to the device (e.g. in order to obtain information relating to a specific home appliance).

The projector typically has a fixed direction of projection relative to the second interaction unit. The second interaction unit can comprise distance sensors, which are configured to detect distance data, which displays the distance of the respective distance sensor in the direction of projection to a surface in the environment of the device. In this case the distance sensors are arranged at different points of the second interaction unit. The control unit can be configured to cause the second interaction unit also to be moved as a function of the distance. In particular an even surface in the environment of the device (e.g. a wall in a room) can be detected on the basis of the distance data. This even surface can then be used if necessary (taking into account the position of the user) as a projection surface for the projector.

The first interaction unit can comprise an input/output unit, which is configured to detect a touch input of the user and/or to generate an optical output to the user via a screen. The input/output unit can in particular have a touch-sensitive screen. Furthermore the device, in particular the first interaction unit, can have an acoustic actuator (e.g. a loudspeaker), which is configured to generate an acoustic output (e.g. speech). An interaction between the device and the user can be improved through the input/output unit and/or through the acoustic actuator.

The device can comprise a communication unit, which is configured to communicate via a communication connection with a home appliance (in particular with a household appliance, such as e.g. an oven, a cooker, a refrigerator etc.) and/or with a server (e.g. with an Internet server and/or with a server outside a household). The communication link can comprise a wireless and/or a wired communication connection (e.g. LAN. WLAN, Bluetooth, UMTS, LTE, etc.).

The control unit can be configured, in response to the input of the user, to obtain information from the home appliance (e.g. a status of the home appliance) and/or from the server (e.g. a recipe). Furthermore the control unit can be configured to cause the projector to present the information in the projected image. By the provision of a communication unit an effective interaction (in particular control and/or monitoring) of home appliances is made possible.

For example the control unit can be configured to obtain instructions for producing a foodstuff (in particular a recipe) from a server (e.g. from an Internet server). The control unit can then control the home appliance depending on the instruction and depending on an input of the user. In this way the production of the foodstuff as a task in a household can be made easier for the user. For example the control unit can be configured, on the basis of the image data relating to the user, to determine the progress of a process in the production of the foodstuff. The home appliance (in particular the household appliance) can then be controlled as a function of the instruction and as a function of the progress of the process (i.e. as a function of the image data).

The control unit can be further configured to determine profile data in relation to the user. The profile data can be stored in a memory unit of the device. Then, as a function of the profile data and as a function of an input of the user, a shopping list can be created. This shopping list can be sent if necessary, using the communication unit, to a remote electronic device (e.g. to a smartphone). Thus the management of food in the household can be made easier for the user.

The control unit can be configured, on the basis of a plurality of inputs of the user, to generate profile data for the user and to store it in the memory unit of the device. The profile data can e.g. display characteristics for identification of the user, preferences of the user and/or habits of the user. This enables the device to be adapted in an efficient way to one or more users.

It should be noted that any of the aspects of the device described in this document can be combined with one another a numerous ways. In particular the features of the claims can be combined with one another in numerous ways.

The invention will be described in greater detail below on the basis of exemplary embodiments, which are shown in the enclosed drawing. In the figures:

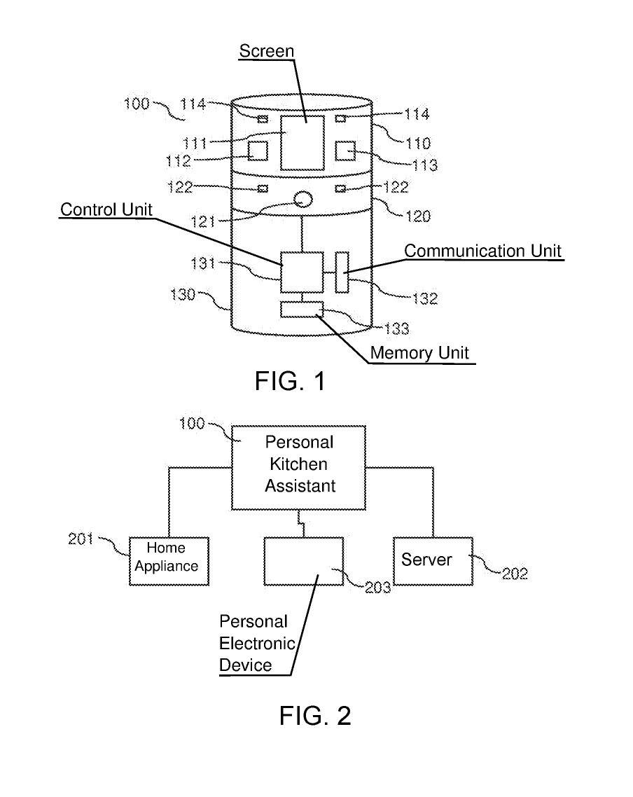

FIG. 1 shows an example of a personal assistant for a household and

FIG. 2 shows examples of communication partners of a personal assistant.

As explained at the outset, the present document deals with assisting a person in a household in the carrying out and in the planning of the plurality of tasks of the household. In this context FIG. 1 shows a device 100, which can be used in particular for the control of home appliances in a household. The device 100 will also be referred to in this document as a personal kitchen assistant or PKA for short. The device 100 is typically the size of a (relatively small) kitchen machine and can e.g. be placed on the worktop of a kitchen.

The PKA 100 comprises a base 130 as well as at least two interaction units 110, 120, which are arranged movably on the base 130. In this case the two interaction units 110, 120 can move independently of one another on the base 130. In the example shown the PKA 100 comprises a first interaction unit 110, which can be rotated around an axis of rotation that runs at right angles to the base 130. Furthermore the PKA 100 shown in FIG. 1 comprises a second interaction unit 120, which likewise (independently of the first interaction unit 110) can be rotated around the axis of rotation. The interaction units 110, 120 can be moved in each case by dedicated actuators (e.g. motors) (not shown in FIG. 1).

The first interaction unit 110 comprises one or more interaction modules 111, 112, 113, 114 for an interaction with a user of the PKA 100, wherein the one or more interaction modules 111, 112, 113, 114 of the first interaction unit 110 should be facing towards the user for the interaction with the user. In particular the first interaction unit 110 can comprise a screen 111 (e.g. a touch-sensitive screen) for output of information and possibly for input of instructions. Furthermore the first interaction unit 110 can comprise a camera 112, which is configured to capture image data, e.g. image data relating to the user of the PKA 100. Moreover the first interaction unit 100 can comprise a loudspeaker 113 for an acoustic output (e.g. for the output of speech and/or of sounds). The first interaction unit 110 can further comprise one or more microphones 114, in order to capture acoustic data or acoustic signals from the environment of the PKA 100 (e.g. spoken instructions of the user).

The second interaction unit 120 can comprise one or more interaction modules 121, which, for an interaction with the user of the PKA 100, should be facing away from the user. In particular the second interaction unit 120 can comprise a projector 121, which is configured to project an image onto a projection surface in the environment of the PKA 100. The image can be projected such that it can be seen by the user from a current position of the user. For this purpose the second interaction unit 120 can be moved in a suitable way (in particular rotated) in order to project the image onto a suitable projection surface. The second interaction unit 120, for determining a suitable projection surface, can also have one or more distance sensors 122, which are configured to determine the distance to a projection surface (e.g. to a wall in a room of the PKA 100). By using at least two distance sensors 122, which are positioned at different points on the interaction unit 120, a suitable projection surface that is as flat or even as possible can be identified for example for the projection of the image.

The PKA 100 further comprises a control unit 131, which is configured to control a movement of the first and second interaction unit 110, 120 and to control one or more functions of the PKA 100. Furthermore the PKA 100 comprises a communication unit 132, which is configured to communicate with other electronic devices via a communication network. This is shown by way of example in FIG. 2. In particular it is shown in FIG. 2 how the PKA 100 can communicate via the communication unit 132 with one or more home appliances 201 in a household, with one or more servers 202 (e.g. Internet servers) and/or with one or more personal electronic devices 203 (e.g. smartphones). The communication unit 132 can be configured for this purpose to establish wired (such as e.g. LAN) and/or wireless (such as e.g. WLAN, Bluetooth, UMTS, LTE etc.) communication links. The control unit 131 and/or the communication unit 132 can be arranged, as shown in FIG. 1, in the base 130 of the PKA 100.

The control unit 131 can be configured to detect a user of the PKA 100. Furthermore the control unit 131 can be configured to determine a position of the user relative to the position of the PKA 100. For example a user can be detected on the basis of the acoustic data and/or on the basis of the image data. For example it can be recognized on the basis of the acoustic data that a user is speaking to the PKA 100. When a plurality of microphones 114 are used, which are arranged at different positions in the PKA 100, a position of the user can be determined (at least roughly) on the basis of delay time displacements of the individual acoustic signals. The first interaction unit 110 can subsequently be caused by the control unit 131 to move the camera 112 in the direction of the determined position of the user. Then, in a second step, on the basis of the image data captured by the camera 112, the position of the user can be determined in a more precise way. The first interaction unit 110 can be moved further in order to guarantee that the screen 111 of the first interaction unit 110 is facing as precisely as possible towards the user. It is thus made possible for the user to view outputs via the screen 111 in an efficient way and/or to make entries via the screen 111. In a corresponding way the camera 112 can also be facing towards the user, to make a reliable input via gestures or facial expressions of the user.

If the position of the user is known, the second interaction unit 120 can be moved such that the projector 121 of the second interaction unit 120 can project an image onto a projection surface, which can be viewed by the user from their current position. In the projected image information about the state of one or more home appliances 201 and/or about method steps of a recipe for a meal to be prepared can be displayed for example.

The PKA 100 can be configured to detect instructions of the user (e.g. by input via the screen 111, by voice input or by gestures or facial expressions). Furthermore the PKA 100 can be configured to carry out actions depending on the instructions. In particular one or more home appliances 201 of the household can be controlled depending on the instructions. For this purpose suitable control signals can be transferred via the communication unit 132 to the one or more home appliances 201.

Examples of functions of the PKA 100 will be presented below. These functions can if necessary be provided individually by the PKA 100. The PKA 100 can make it possible by means of the communication unit 132 for there to be bidirectional communication between PKA 100 and one or more home appliances 201 or other electronic devices 203. In this case status information relating to the state of a home appliance 201 or electronic device 203 can be transferred in particular to the PKA 100. There can be a bidirectional communication between PKA 100 and one or more users by projection (by means of the projector 121) and/or voice (by means of one or more microphones 114).

The presence of a user can be recognized and the user identification carried out by face and/or voice recognition on the basis of the image data and/or on the basis of the acoustic data. For evaluating voice inputs of a user an intuitive voice control, in particular be means of NLP (Natural Language Processing) can be used.

The PKA 100 can comprise a memory unit 133 in which profiles for one or more users of the PKA 100 can be stored. In particular preferences and habits of a user can be stored in the profile of a user. For example preferred foods can be stored, which can be taken into account in the creation of a shopping list (e.g. after detection of the current status of the contents of a refrigerator).

The PKA 100 can comprise a battery or a rechargeable battery, which are configured to store energy for the operation of the PKA 100. The PKA 100 can thus be mobile and portable.

The PKA 100 can be controlled via voice, gestures and/or facial expressions (via face detection) by a user. Furthermore the PKA 100 can be configured, on the basis of the image data and/or on the basis of the acoustic data, to establish a state of mind of the user (such as e.g. satisfied, dissatisfied, encouraging, rejecting). The operation of the PKA 100 can then be adapted to the state of mind determined (e.g. the colors used for the projection can be adapted to the state of mind). The interaction with a user can be improved in this way.

The PKA 100 can be configured, by means of the projector 121 (e.g. by means of a pico projector) to project content onto a projector surface. The projected content can be requested beforehand by the user (e.g. by voice). The content can be determined on the instruction of the user (if necessary as a function of a current context) and then projected. For example the results of a search request can be determined and projected by the PKA 100.

In an example of an application the user can have a shopping list created on instruction by the PKA 100. For this purpose there can be access if necessary to a default shopping list in the memory unit 133. Furthermore the contents of a refrigerator 201 can be determined. Then, (e.g. by forming the difference between the default shopping list and the contents of the refrigerator) a shopping list can be determined and output via the projector 121. This list can be adapted depending on inputs (e.g. gesture inputs). Furthermore, by interrogating one or more servers 202, current prices for the elements of the shopping list can be determined (e.g. from different suppliers). A suitable supplier can then be chosen. If necessary the shopping list can be transferred from the PKA 100 to the personal device 203 of a further person, with the request to purchase the listed elements from the chosen supplier.

The PKA 100 can be configured to assist a user in the creation of a foodstuff (e.g. a baked item or a meal). In conjunction with such an application example further functions of the PKA 100 will be described, which can also be provided isolated from this application example by the PKA 100.

By direct access a wake-up function of the PKA 100 (i.e. a transition from an idle state into an active state) can be instigated. The PKA 100 can automatically identify possible free projection surfaces and bring about an autonomous mechanical rotation of the projector 121 or of the second interaction unit 120 into the correct projection position. In this case there is preferably a mechatronic decoupling of the projection system (i.e. of the second interaction unit 120) from the system for gesture recognition (i.e. of the first interaction unit 110), e.g. so that the projection system (i.e. the second interaction unit 120) with horizontal and/or vertical axis can carry out a 360° pivotable movement in the horizontal and/or vertical movement, while the gesture recognition system (i.e. the first interaction unit 110) rotates towards the user and holds the face fixed and thus suggests to the user its attention and can correctly recognize gestures. The control unit 131 of the PKA 100 can thus be configured, on the basis of the image data of the optical sensor 112, to identify a head of the user and to cause the first interaction unit 110 to be moved so that the head of the user remains in the sensed region of the optical sensor 112.

The PKA 100 can be configured to generate gestures for communication with the user, e.g. by turning the screen 111 of the first interaction unit towards them or away from them or by horizontal shaking/vertical nodding of the first interaction unit 110 as interactive feedback for the user. For example an explicit ignoring or agreement, pleasure etc., can be suggested by the movement of the first interaction unit 110. Thus the PKA 100 can be configured, by movement of an interaction unit 110, to communicate with a user. Furthermore the PKA 100 can comprise a vibration source as additional feedback.

The PKA 100 can be configured to recognize the presence of the user on the basis of acoustic data and/or image data. Furthermore entries of the user can be made via voice input (in particular via intuitive voice control, e.g. by means of Natural Language Processing).

In response to an input the PKA 100 can set up a communication connection to a local and/or to an external recipe database. Recipes tailored to the user can be determined and output via the projector 121 in the form of lists or images. In such cases recipe suggestions can be displayed differentiated, e.g. differentiated according to ingredients and equipment available in the household and on the other side in accordance with ingredients and equipment not available and still to be purchased. The recipe suggestions can if necessary be adapted to an impending event, e.g. birthday, evening meal, brunch etc.

Furthermore the PKA 100 can be configured to synchronize the planned preparation time for a selected recipe with a user's schedule and where necessary inform the user that the required preparation time conflicts with their schedule. The user can then look for another recipe if necessary. Moreover there can be synchronization with other PAs 100 (e.g. in other households), e.g. as regards the availability of ingredients. This enables the user to be notified that a specific ingredient is available in a neighboring household.

The PKA 100 can have an option for inputting or for automatically detecting the equipment available in a household, e.g. by RFID tags and/or by direct image recognition and/or by verbal description by the user. Inputs, such as a selection or an interaction, of the user can be made by voice control and/or by gesture recognition.

The PKA 100 can be configured to control home appliances 201 via the communication unit 132 or to interrogate a status relating to the home appliances 201. In this case the home appliances 201 can comprise a refrigerator, a cooker, a vacuum cleaner, a mixer, a kitchen machine, a multi-cooker, small appliances etc. In particular home appliances 201 can be controlled in accordance with the selected recipe. For example an occupancy level or a contents of a refrigerator can be determined. Furthermore a cooker can be controlled in accordance with the progress of the process of the recipe, e.g. by interactive preheating, by program selection, by the selection of multi-stage programs, by the setting of a timer, by deactivation etc. Moreover a mixer can be controlled, e.g. by automatic switching on and switching off by means of voice commands or gestures of the user. In this case duration, rotational speed appropriate to the recipe can be selected in advance. Moreover a robot vacuum cleaner can be activated in order for example to clean the kitchen after the recipe has been completed. The PKA 100 can further be configured, when a baking process has finished, to cause the oven door to be opened and/or to cause a telescopic pullout shelf to be deployed.

Further examples of functions of the PKA 100 will be described below by a further example. The PKA 100 can have the individual functions in isolation (e.g. independent of the example shown). As already illustrated, the PKA 100 can be put into an active state by voice control. The PKA 100 can be portable and/or mobile. Furthermore the PKA 100 can be operated by a battery (which can be charged by a stationary charging station if necessary). The PKA 100 can also have an alarm function.

By the use of at least two microphones 114 the position of a user/speaker can be determined (e.g. with an accuracy of +/−10%). Objects in the environment of the PKA 100 can if necessary be recognized by the PKA 100 through RFID tags.

The PKA 100 can be configured to obtain access to media databases via a communication connection (e.g. on a message channel). Information from a media database can be determined and displayed via the projector 121. In such cases account can be taken of user preferences (which if necessary can be learned automatically by the PKA 100). Furthermore the displayed information can be selected as a function of the persons present in the environment of the PKA 100. In addition the contents can be divided up in accordance with areas of interest of the persons present in the environment of the PKA 100.

The PKA can provide a reminder or notification function. For example, in response to a weather forecast a notification to take an umbrella with you can be given. The PKA 100 can interact via the communication unit 131 with entertainment systems in the household, such as TV, radio etc. In particular these devices can be controlled remotely by the PKA 100.

The PKA 100 can interact with personal electronic devices 203. For example the location of an owner of the electronic device 203 can be determined via a personal electronic device 203. The location can then be output by the PKA 100. The PKA 100 can communicate via the communication unit 132 with home technology in a household. For example pictures of a camera at the entrance to the house can be determined and output via the PKA 100. Furthermore the PKA 100 can be configured to provide a connection to a door phone, in order to be able to communicate directly from the PKA 100 with a person at the door and if necessary operate a door opener.

The PKA 100 can provide a video conference system for interaction with further persons by microphone and projection and Internet connection. In particular outgoing conference data can be provided via the camera 112 and via a microphone 114, which can be sent to a conference partner. On the other side incoming conference data from the conference partner can be output via the projector 121 and via the loudspeaker 113.

The PKA can be configured to access a software database in order to obtain software updates and/or software applications for an expanded range of functions.

The PKA 100 thus makes possible a plurality of different functions for assisting a user in a household, in particular an automatic interaction with home appliances 201 is made possible, such as e.g. a control of an oven, of a dishwasher, of a kitchen machine etc. In such cases the user intervenes only indirectly in the control, in that the user selects a cooking recipe and starts the preparation of an appropriate dough. The PKA 100 analyzes actions of the user and draws conclusions in respect of the timing of the device control and checks the home appliances 100 interactively with the user. For this purpose the PKA 100 can evaluate image data relating to the user practically continuously in order to determine the progress of the process.

There can be autonomous communication between a number of PKAs 100, e.g. for a synchronization of the refrigerator contents of neighboring households, for a synchronization of cooked recipes etc. Furthermore there can be an adaptive interaction with the user, such as e.g. a learning and subsequently recognizing the state of mind of the user on the basis of visual and/or acoustic features. The PKA 100 can be configured, via output of voice and/or via simulation of facial expression/gesture, to communicate with the user (e.g. by real or virtual movement of the hardware or software components of the PKA 100, which simulate a natural human reaction).

The PKA 100 can be configured to carry out a synchronization with a calendar and/or with habits of the user(s), as well as with online services, repeating tasks etc., and to output relevant information in relation to the synchronization of the voice output or projection. Furthermore there can be an automatic synchronization of needs of the user, e.g. a meal requirement, a recipe requirement etc., with sources in the Internet, e.g. with ordering platforms for meals, with online businesses etc.

The present invention is not restricted to the exemplary embodiments shown. It is to be noted in particular that the description and the figures are only intended to illustrate the principle of the proposed device.

1-15. (canceled)

16. A device for assisting a user in a household, the device comprising:
a base for placing the device on a standing surface;
a first interaction unit including an optical sensor configured to capture image data of a sensed region of an environment of the device, said first interaction unit being movable relative to said base for changing said sensed region;
a second interaction unit including a projector configured to project an image onto a projection surface in the environment of the device, said second interaction unit being movable separately from said first interaction unit for changing the projection surface of said projector; and
a control unit configured:
to determine a position of a user of the device in the environment of the device;
to cause each of said first interaction unit and said second interaction unit to be moved in dependence on the position of the user;
to determine an input of the user; and
to cause said projector to project an image onto the projection surface in response to the input.

17. The device according to claim 16, wherein said control unit is configured to cause:
said first interaction unit to be moved such that the user is located at least partly in the sensed region of said optical sensor; and
said second interaction unit to be moved such that both the projection surface and also the device lie in a field of view of the user.

18. The device according to claim 16, which further comprises:
acoustic sensors each configured to detect acoustic data relating to acoustic signals in the environment of the device;
said acoustic sensors being disposed at different locations of the device; and
said control unit configured:
to detect a presence of the user in the environment of the device based on the acoustic data; and
to determine the position of the user based on the acoustic data of said acoustic sensors.

19. The device according to claim 18, wherein said control unit is configured:
to determine a first position of the user based on the acoustic data of said acoustic sensors;
to cause said first interaction unit to be moved in dependence on the first position of the user, so that the user is located at least partly in the sensed region of said optical sensor;
to determine a second position of the user based on the image data; and
to cause said first interaction unit and said second interaction unit to be moved depending on the second position of the user.

20. The device according to claim 18, which further comprises:
a memory unit configured to store profile data in relation to one or more predefined users;
said control unit being configured, based on the profile data and also based on at least one of the acoustic data or the image data, to determine whether the user corresponds to a predefined user.

21. The device according to claim 18, wherein said control unit is configured to transfer the device from a sleep mode into an active mode, depending on the acoustic data.

22. The device according to claim 18, wherein said control unit is configured to determine the input of the user based on the acoustic data.

23. The device according to claim 16, wherein:
said projector has a direction of projection relative to said second interaction unit;
said second interaction unit includes distance sensors configured to detect distance data and to display a distance from a respective distance sensor in the projection direction to a surface in the environment of the device;
said distance sensors being disposed at different locations of said second interaction unit; and
said control unit being configured to cause said second interaction unit to also be moved depending on the distance data.

24. The device according to claim 16, wherein said first interaction unit includes an input/output unit configured to at least one of detect a touch input of the user or generate an optical output to the user on a screen.

25. The device according to claim 16, which further comprises an acoustic actuator configured to generate an acoustic output.

26. The device according to claim 16, wherein said first interaction unit includes an acoustic actuator configured to generate an acoustic output.

27. The device according to claim 16, which further comprises:
a communication unit configured to communicate over a communication connection with at least one of a home appliance or a server;
said control unit being configured to obtain information from at least one of the home appliance or the server, in response to an input; and
said control unit being configured to cause said projector to display the information in the projected image.

28. The device according to claim 27, wherein said control unit is configured:
to obtain an instruction for creating a foodstuff from the server; and
to control the home appliance in dependence on the instruction and in dependence on an input of the user.

29. The device according to claim 27, wherein said control unit is configured:
to determine profile data in relation to the user;
to create a shopping list in dependence on the profile data and in dependence on an input of the user; and
to send the shopping list, using the communication unit, to a remote electronic device.

30. The device according to claim 27, which further comprises:
a memory unit;
said control unit being configured to generate profile data for the user and to store the profile data in a memory unit of the device based on a plurality of inputs of the user;
the profile data showing characteristics for at least one of identification of the user, preferences of the user or habits of the user.

31. The device according to claim 16, which further comprises:
a first actuator configured to move said first interaction unit around a first axis of rotation in response to a first control signal of said control unit, in order to make possible different sensed regions in a horizontal angular range of 360° around the device; and
a second actuator configured to move said second interaction unit around a second axis of rotation in response to a second control signal of said control unit, in order to make possible different projection surfaces in a horizontal angular range of 360° around the device.

32. The device according to claim 16, which further comprises an actuator configured to move said first interaction unit around an axis of rotation in response to a control signal of said control unit, in order to make possible different sensed regions in a horizontal angular range of 360° around the device.

33. The device according to claim 16, which further comprises an actuator configured to move said second interaction unit around an axis of rotation in response to a control signal of said control unit, in order to make possible different projection surfaces in a horizontal angular range of 360° around the device.
